(19) United States
(12) Patent Application Publication
(10) Pub. No.: US 2006/0234535 A1
(43) Pub. Date: Oct. 19, 2006

(54) Set of connectors

(75) Inventors: Kazuto Ohtaka, Shizuoka (JP); Hideki Ohsumi, Shizuoka (JP); Toshiharu Takahashi, Shizuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: YAZAKI CORPORATION, Tokyo (JP)

(21) Appl. No.: 11/405,439

(22) Filed: Apr. 18, 2006

(30) Foreign Application Priority Data
Apr. 18, 2005 (JP) 2005-120156
Feb. 8, 2006 (JP) 2006-031547

(51) Int. Cl. H01R 13/62

(52) U.S. Cl. 439/157

(57) ABSTRACT

Providing a set of lever-type connectors, which can be miniaturized, the set of connectors includes a male connector, a female connector and a lever mounted rotatably on the male connector. The connectors are made close to and apart from each other by rotating the lever. A lock arm is provided at the male connector. A lock projection engaging with the lock arm is provide at the female connector.

The priority application Number Japan Patent Application 2006-031547 upon which this patent application is based is hereby incorporated by reference.

### BACKGROUND OF THE INVENTION

1. Field of the Invention

This invention relates to a set of connectors including a first connector, a second connector and a lever mounted rotatably on one of the connectors to be fitted to each other.

2. Description of the Related Art

A lever-type connector, which has a lever, is known (for example References see below).

FIG. 22 is a cross-sectional view showing a male housing and a female housing of a lever-type connector disclosed in the Patent document 1 before fitting them. FIG. 23 is a cross-sectional view showing a condition of that the male housing is fitted into the female housing shown in FIG. 22.

According to the lever-type connector 100 in FIGS. 22, 23, a lever 101 is engaged at an engaging hole 102 provided at the lever 101 with a projection 104 of a male housing 103 and supported rotatably around a projection 104 on a male housing 103.

The lever 101 rotates on the male housing 103 so as to make the female housing 105 and male housing 103 close to each other and fit together. In other words, with interlocking to rotation of the lever 101, the male housing 103 is received into a hood 106 of the female housing 105. By engaging a lock projection 107 of the hood 106 with a lock (not shown) of the lever 101, the lever 101 is locked. Thus, the lever 101 is locked so that fitting of the housings 103, 105 is maintained. When the lever 101 of the above lever-type connector 100 is not used, it is very difficult to fit the housings 103, 105 to each other. In other words, for fitting the housings 103, 105 to each other, a strong force for making the housings 103, 105 close to each other is required.

References are Japan Patent Published No. 2002-359028 and 2003-92169.

### SUMMARY OF THE INVENTION

Objects to be Solved

The usual lever-type connector 100, as shown in FIGS. 22, 23, cannot be provided in a narrow space where the lever 101 cannot be arranged, since the lever 101 maintains fitting of the housings 103, 105. If the lever 101 is eliminated, the fitting of the connectors 103, 105 cannot be maintained.

In the aforesaid lever-type connector 100, since the lever 101 maintains fitting of the housings 103, 105, the fitting of the housings 103, 105 cannot be maintained when the lever 101 is broken. Therefore, design of mechanically strong lever is required so that the lever 101 will be enlarged. Thus, the aforesaid lever-type connector 100 is required to have the relatively large lever 101, which has enough mechanical strength not to be broken if other object hits the lever 101. A space for providing the lever 101 is enlarged.

To overcome the above problems, an object of this invention is to provide a connector including a lever, which can be miniaturized.

How to Attain the Object of the Present Invention

In order to attain the objects of the present invention, a set of connectors includes a first connector having a lock arm; a second connector having a lock projection to be engaged with the lock arm and fitting with the first connector by engaging the lock projection and the lock arm; a lever provided rotatably on any one of the first connector and the second connector so as to rotate for moving the first connector and the second connector to be close to each other and be apart from each other; interlocking release member releasing engagement of the lock arm and the lock projection by interlocking with a rotation of the lever for separating the first connector and the second connector, which are fitted together, from each other; and a fitting hold member holding to fit the first connector and the second connector together until the engagement of the lock arm and the lock projection is released even if the lever rotates.

The set of connectors is further characterized in the set of connectors mentioned above in that one end of the lock arm is continued to the first connector and the other end of the lock arm is formed into a free end to be engaged with the lock projection of the second connector, and the interlocking release member includes a first release member provided at the lever for deforming elastically the lock arm so as to release the engagement of the lock arm and the lock projection by penetrating between the first connector and the other end of the lock arm when the lever is rotated in a condition that the first connector and the second connector are fitted together.

The set of connectors is further characterized in the set of connectors mentioned above in that one end of the lock arm is continued to the first connector and the other end of the lock arm is formed into a free end to be engaged with the lock projection of the second connector, wherein the interlocking release member includes a second release member provided at the lever for deforming elastically the lock arm so as to release the engagement of the lock arm and the lock projection by pushing the one end of the lock arm toward the first connector when the lever is rotated in a condition that the first connector and the second connector are fitted together.

The set of connectors is further characterized in the set of connectors mentioned above in that the second release member includes a pushing portion projecting from the lever toward the lock arm, and a guide groove provided at the lock arm and extending in a direction of moving the first connector and the second connector to be close to and apart from each other for guiding motion of the pushing portion to penetrate into the guide groove when the lever is rotated.

The set of connectors is further characterized in the set of connectors mentioned above in that any one of the first connector and the second connector, on which the lever is provided, is provided with a pair of guide projections extending in the direction of moving the first connector and the second connector to be close to and apart from each other for guiding motion of the pushing portion to penetrate between the pair of guide projections when the lever is rotated.

The set of connectors is further characterized in the set of connectors mentioned above in that a fitting guide projection is provided on any one of the other of the first connector and the second connector and the lever, and the fitting guide projection projects toward the other of the other of the first connector and the second connector and the lever, and a fitting guide groove, into which the fitting projection penetrates, is provided the other of the other of the first connector and the second connector and the lever, and the first connector and the second connector are moved to be close to and apart from each other by moving the fitting guide projection in the fitting guide groove when the lever is rotated, and the fitting hold member is formed with a space arranged between the fitting guide projection and the fitting guide groove so as to remain the space between the fitting guide projection and the fitting guide groove until the interlocking release member releases the engagement of the lock arm and the lock projection.

The set of connectors is further characterized in the set of connectors mentioned above in that a temporarily lock is provided for locking the lever when the first connector and the second connector are separated, and releasing a locking of the temporarily lock interlockingly with approaching of the first and second connectors to each other when the first and second connectors are fitted.

### EFFECTS OF THE INVENTION

According to the invention, since the first connector and the second connector can be maintained to be fitted to each other without providing the lever, after fitting the connectors to each other by using the lever, the lever can be removed and when the lever is broken, the connectors can be maintained to be fitted together.

Therefore, mechanical strength of the lever can be reduced for miniaturizing the lever so that the connectors can be also miniaturized. In case, the set of connectors according to the present invention can be used even if the lever is removed. Therefore, a space for applying the set of connectors can be miniaturized and the set of connectors can be applied in a narrow space.

Since the interlocking release member releases the engagement of the lock arm and the lock projection with interlocking to rotation of the lever, the connectors can be separated to each other securely by rotation of the lever. Therefore, the connectors can be separated securely without damage of the lock arm and the lock projection.

Before the engagement of the lock arm and the lock projection is released when the connectors are separated, the connectors can be prevented from moving to be separated. Thereby, the lock arm and the lock projection can be prevented from damage. Therefore, the connectors can be separated securely without damage of the lock arm and the lock projection.

According to the invention, since the first release member of the interlocking release member penetrates between the other end of the lock arm and the first connector, the engagement of the lock arm and the lock projection can be released securely.

According to the invention, since the second release member of the interlocking member pushes the one end of the lock arm toward the first connector, the engagement of the lock arm and the lock projection can be released securely.

According to the invention, since the rotation of the lever is guided by the second release member and the guide groove, even if the mechanical strength of the lever is reduced for miniaturizing the lever, the lever will not be damaged. Therefore, the connectors can be made close to and apart from each other securely by rotating the lever.

According to the invention, since the rotation of the lever is guided by the second release member and the pair of guide projections, even if the mechanical strength of the lever is reduced for miniaturizing the lever, the lever will not be damaged. Therefore, the connectors can be made close to and apart from each other securely by rotating the lever.

According to the invention, since the fitting hold member is formed with the space arranged between the fitting guide projection and the fitting guide groove, the fitting hold member makes the first connector and the second connector unmoved (stopped) relatively, until the engagement of the lock arm and the lock projection is released. Therefore, the connectors can be separated securely without damage of the lock arm and the lock projection.

According to the invention, since the temporarily lock is provided, the lever is prevented from rotating when the first connector and the second connector are separated. When the connectors are separated, the lever can be prevented from positioning in a position where the lever is positioned at fitting of the connectors together.

The above and other objects and features of this invention will become more apparent from the following description taken in conjunction with the accompanying drawings.

### BRIEF DESCRIPTION OF THE DRAWINGS

FIG. 1 is a perspective view of a female connector and a male connector before fitting of a set of connectors of an embodiment according to the present invention;

FIG. 2 is a perspective view of the set of connectors shown in FIG. 1, an outer over of the female connector being partially cross-sectioned;

FIG. 3 is a cross-sectional view of the set of connectors shown in FIG. 1 at a position where a lock arm of the female connector can be seen;

FIG. 4 is a cross-sectional view of the set of connectors shown in FIG. 1 at a position where a release arm of a lever the female connector can be seen;

FIG. 5 is a perspective view of the female connector and the male connector starting to be fitted of the set of connectors shown in FIG. 1;

FIG. 6 is a perspective view of the set of connectors shown in FIG. 5, the outer over of the female connector being partially cross-sectioned;

FIG. 7 is a cross-sectional view of the set of connectors shown in FIG. 5 at the position where the lock arm of the female connector can be seen;

FIG. 8 is a cross-sectional view of the set of connectors shown in FIG. 5 at the position where the release arm of the lever the female connector can be seen;

FIG. 9 a perspective view of the female connector and the male connector just before complete fitting of the set of connectors shown in FIG. 1;

FIG. 10 is a perspective view of the set of connectors shown in FIG. 9, the outer over of the female connector being partially cross-sectioned;

FIG. 11 is a cross-sectional view of the set of connectors shown in FIG. 9 at the position where the lock arm of the female connector can be seen;

FIG. 12 is a cross-sectional view of the set of connectors shown in FIG. 9 at the position where the release arm of the lever the female connector can be seen;

FIG. 13 a perspective view of the female connector and the male connector in the complete fitting of the set of connectors shown in FIG. 1;

FIG. 14 is a perspective view of the set of connectors shown in FIG. 13, the outer over of the female connector being partially cross-sectioned;

FIG. 15 is a cross-sectional view of the set of connectors shown in FIG. 13 at the position where the lock arm of the female connector can be seen;

FIG. 16 is a cross-sectional view of the set of connectors shown in FIG. 13 at the position where the release arm of the lever the female connector can be seen;

FIG. 17 is a partially expanded cross-sectional view of the lock arm and a second release member of the set of connectors shown in FIG. 15;

FIG. 18 is a partially expanded cross-sectional view of the second release member releasing an engagement of a lock projection of the lock arm shown in FIG. 17;

FIG. 19 is a partially expanded cross-sectional view of the lock arm and the second temporarily lock of the set of connectors shown in FIG. 3;

FIG. 20A is a partially expanded cross-sectional view of the lock arm and a first release member of the set of connectors shown in FIG. 16;

FIG. 20B is a plan view illustrating a positional relation of an interference member of the first release member and a release projection shown in FIG. 20A;

FIG. 21A is a partially expanded cross-sectional view of the first release member releasing the engagement of the lock arm and the lock projection shown in FIG. 20A;

FIG. 21B is a plan view illustrating a positional relation of the interference member of the first release member and the release projection shown in FIG. 21A;

FIG. 22 a cross-sectional view of a female connector and a male connector before fitting of a lever-type connectors by prior art; and

FIG. 23 a cross-sectional view of the female connector and the male connector in fitting of the lever-type connectors shown in FIG. 22.

### DESCRIPTION OF THE PREFERRED EMBODIMENT

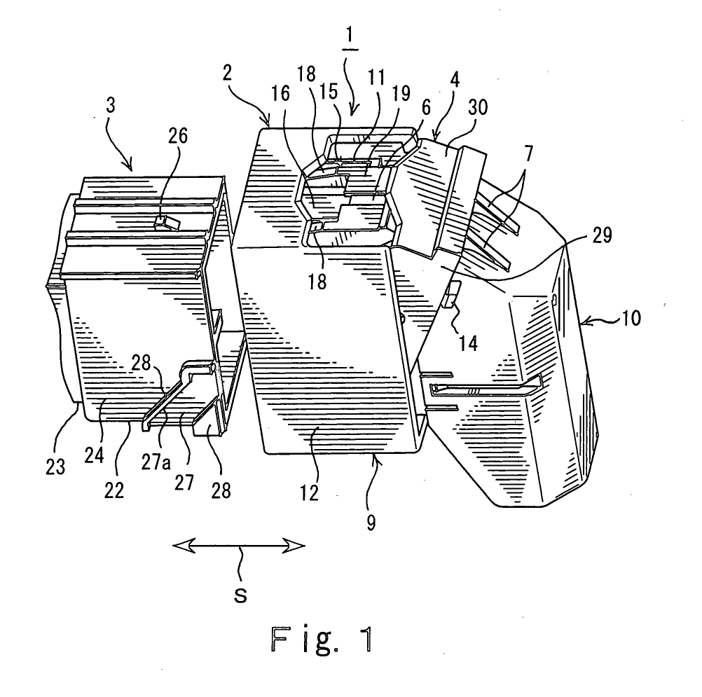

A set of connectors of an embodiment according to the present invention will be described with reference to FIGS. 1-21.

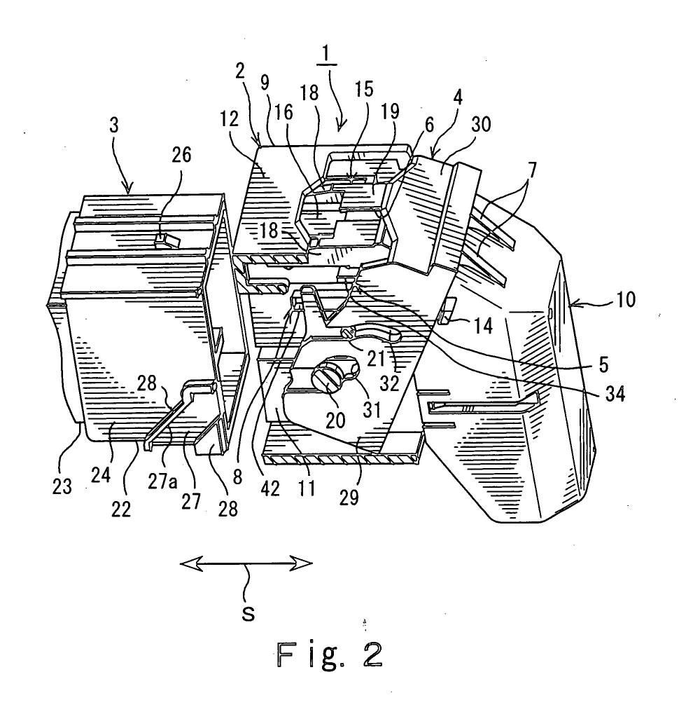

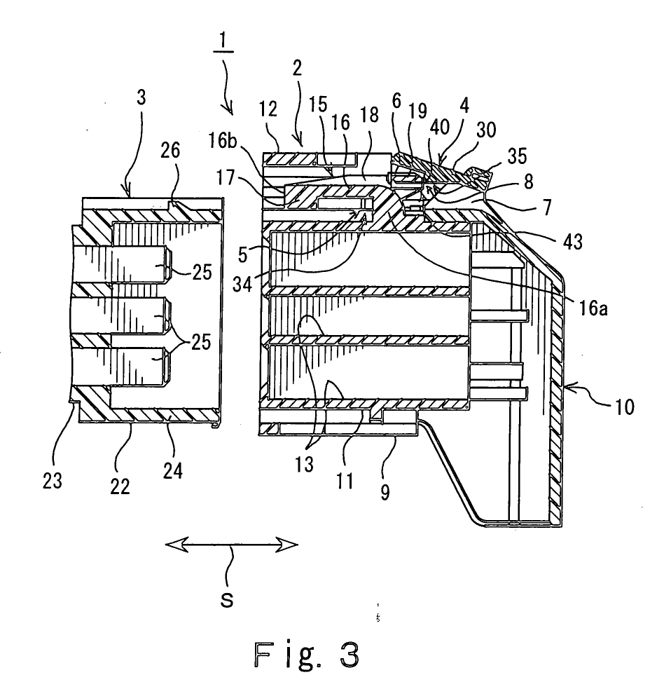

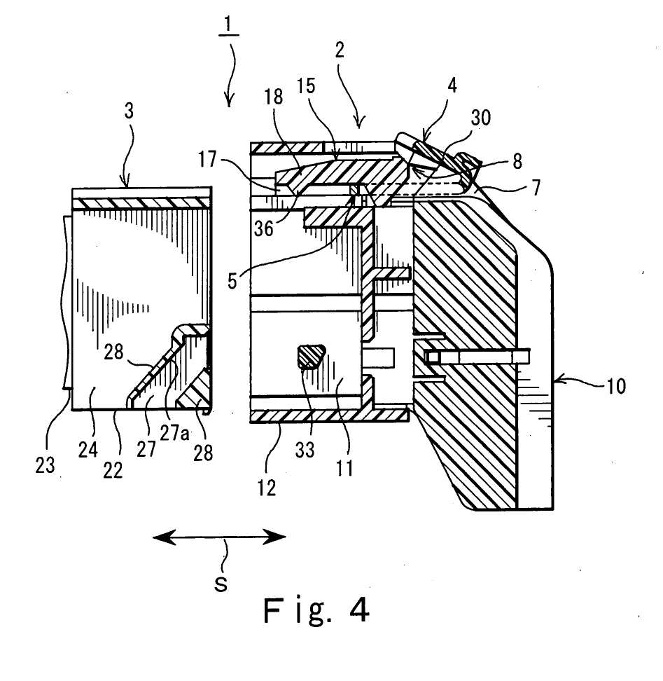

FIG. 1 is a perspective view of a male connector and a female connector, before fitting together, of the set of connectors of the embodiment according to the present invention. FIG. 2 is a perspective view of the set of connectors in FIG. 1, an outer cover of the female connector of which is partially removed. FIG. 3 is a cross-sectional view at a position where a lock arm of the female connector of the set of connectors in FIG. 1 can be seen. FIG. 4 is a cross-sectional view at a position where a release arm of a lever of the set of connectors in FIG. 1 can be seen.

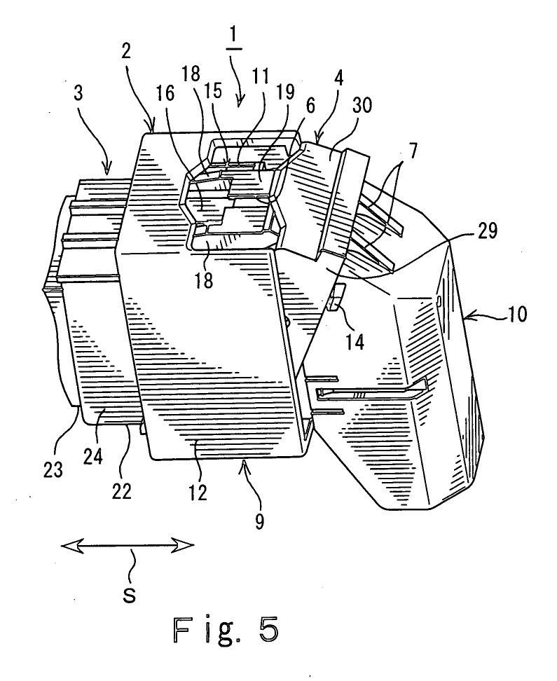

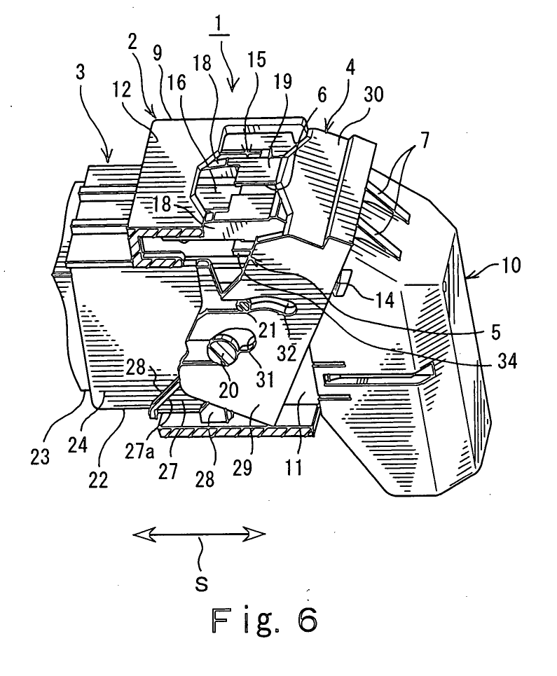

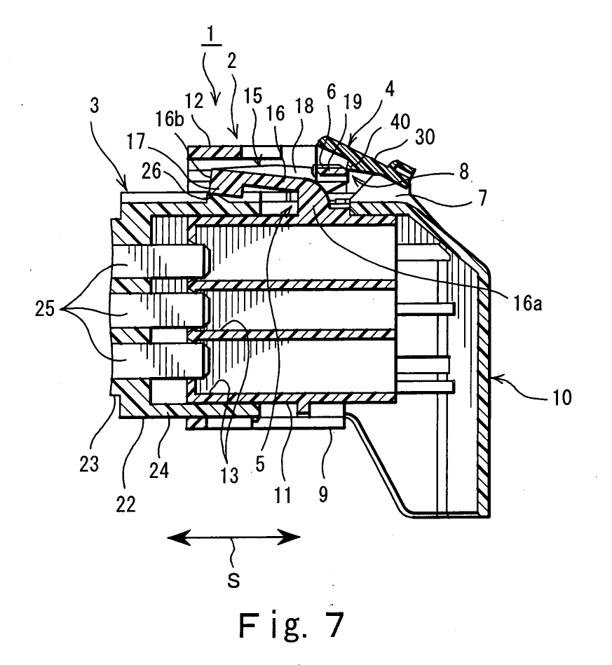

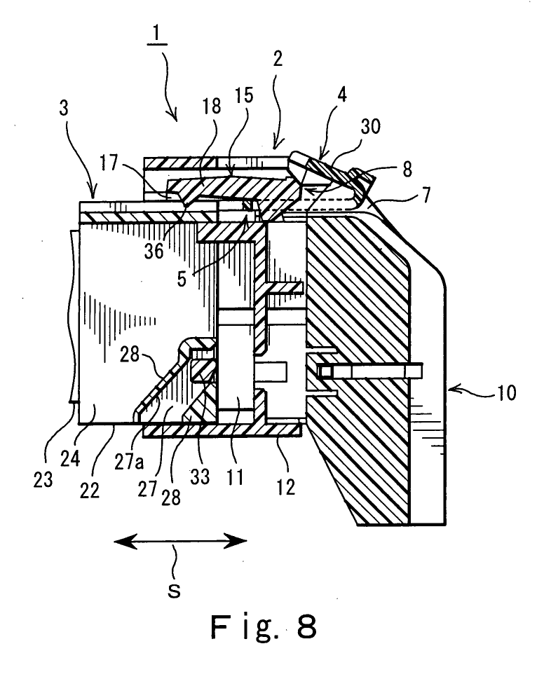

FIG. 5 is a perspective view of a male connector and a female connector, just starting to be fitted together, of the set of connectors of the embodiment according to the present invention. FIG. 6 is a perspective view of the set of connectors in FIG. 5, an outer cover of the female connector of which is partially removed. FIG. 7 is a cross-sectional view at a position where a lock arm of the female connector of the set of connectors in FIG. 5 can be seen. FIG. 8 is a cross-sectional view at a position where a release arm of a lever of the set of connectors in FIG. 5 can be seen.

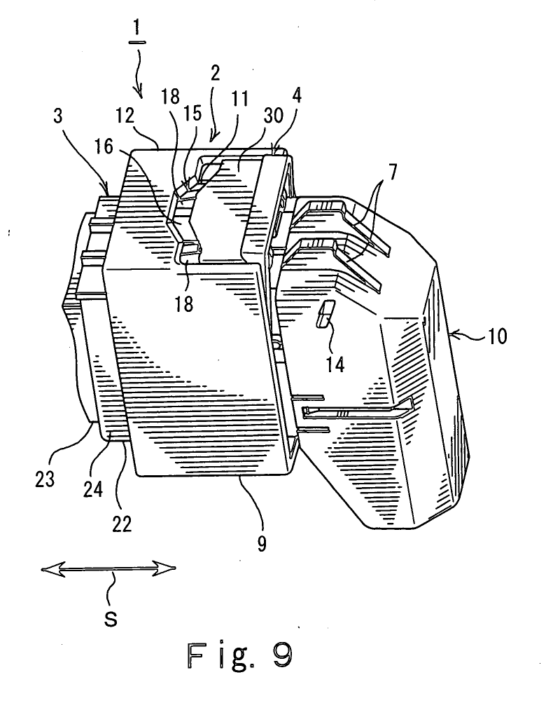

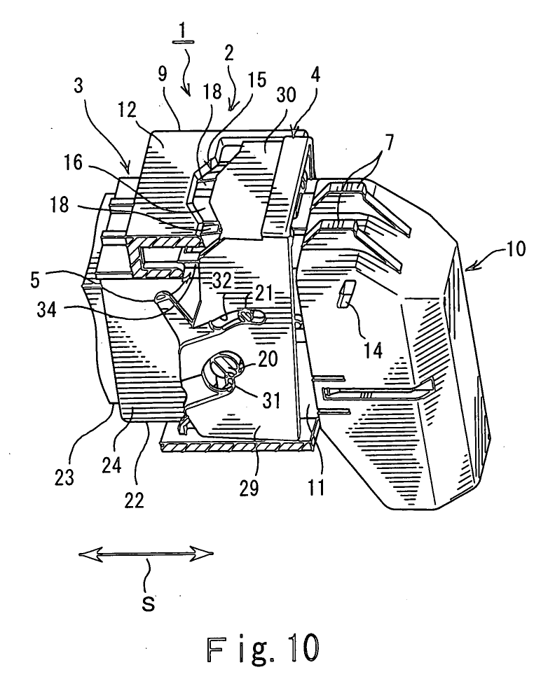

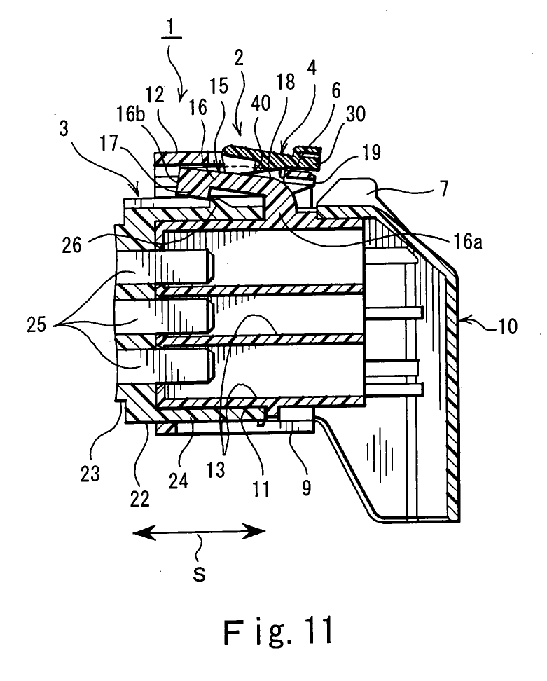

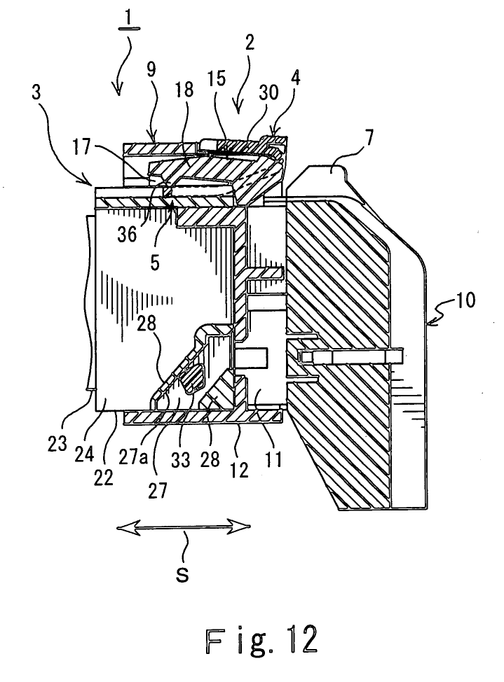

FIG. 9 is a perspective view of a male connector and a female connector, just before fitting together completely, of the set of connectors of the embodiment according to the present invention. FIG. 10 is a perspective view of the set of connectors in FIG. 9, an outer cover of the female connector of which is partially removed. FIG. 11 is a cross-sectional view at a position where a lock arm of the female connector of the set of connectors in FIG. 9 can be seen. FIG. 12 is a cross-sectional view at a position where a release arm of a lever of the set of connectors in FIG. 9 can be seen.

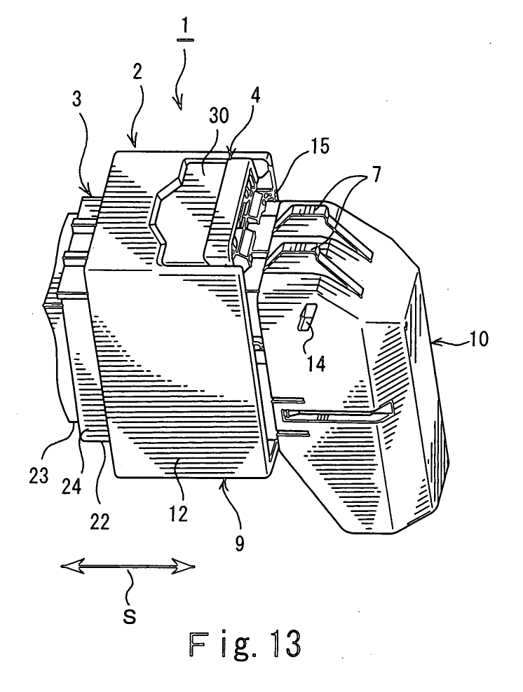

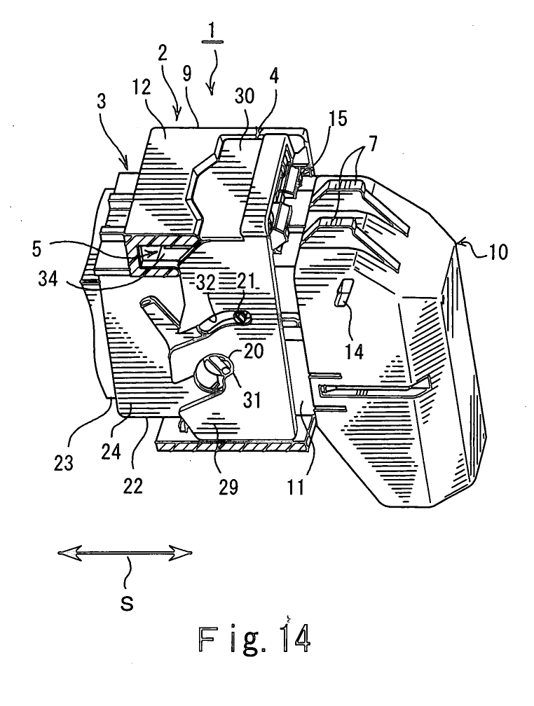

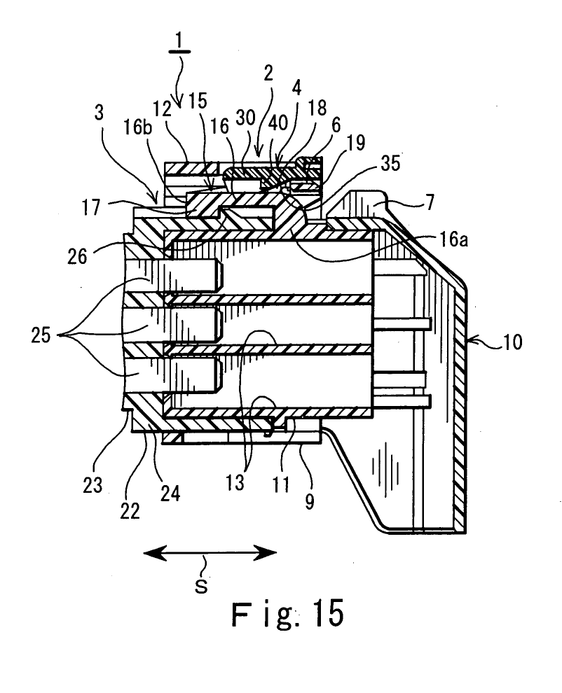

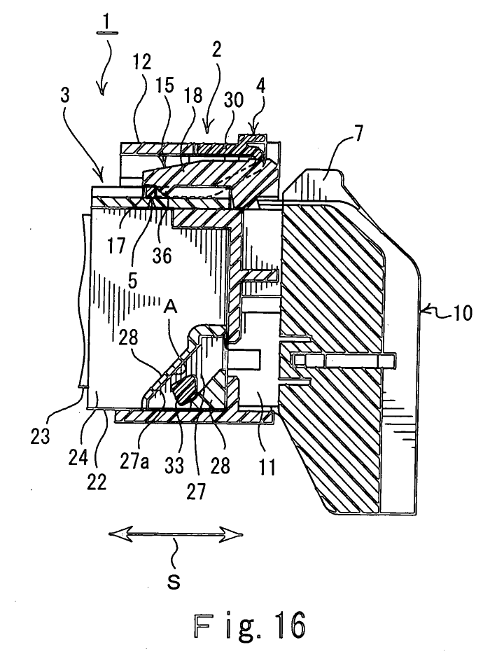

FIG. 13 is a perspective view of a male connector and a female connector, just fitting together completely, of the set of connectors of the embodiment according to the present invention. FIG. 14 is a perspective view of the set of connectors in FIG. 13, an outer cover of the female connector of which is partially removed. FIG. 15 is a cross-sectional view at a position where a lock arm of the female connector of the set of connectors in FIG. 13 can be seen. FIG. 16 is a cross-sectional view at a position where a release arm of a lever of the set of connectors in FIG. 13 can be seen.

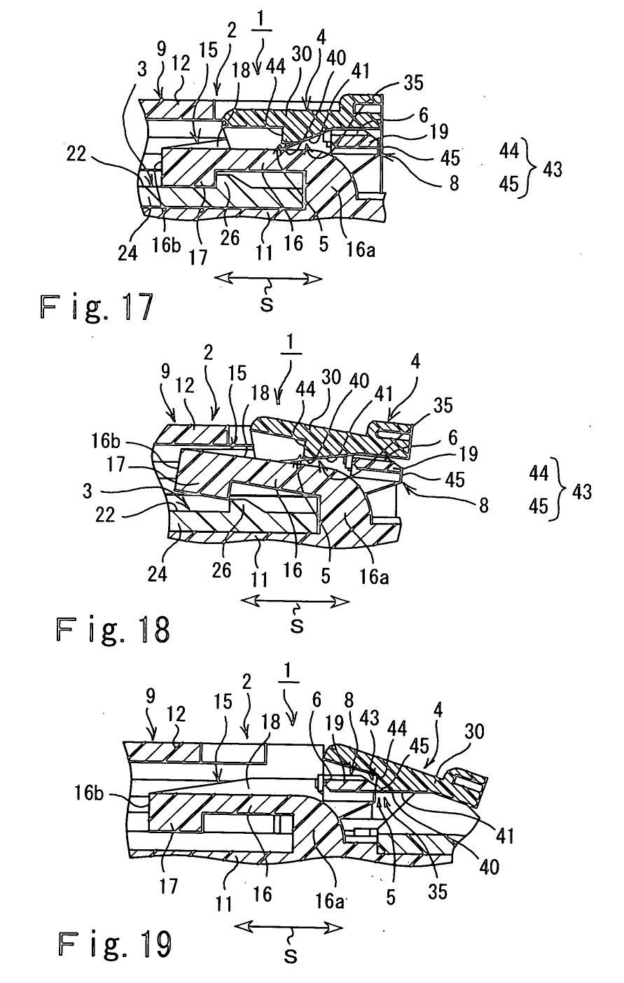

A set of connectors 1, as shown in FIGS. 1-16, includes a male connector 2 as the first connector, a female connector 3 as the second connector, a lever 4, an interlocking release member 5 (shown in FIGS. 17-19, 20-21), a pair of guide projections 7 (shown in FIG. 1) and a temporarily lock 8 (shown in FIGS. 2, 19).

The male connector 2 includes a connector housing 9 and an over 10. The connector housing 9 has a box-shape inner housing 11 and a tubular outer cover 12, as shown in FIG. 2. The inner housing 11 is provided with terminal receiving sections 13 (shown in FIG. 3) for receiving a plurality of female terminals (not shown) therein.

The outer cover 12 is formed integrally with the inner housing 11 so as to receive the inner housing 11 inside thereof. An edge of the outer cover 12 at a side apart from the female connector 3 is continued to an outer edge of the inner housing 11.

The cover 10 is formed into a gutter-shape, and mounted at an edge of the inner housing 11 of the connector housing 9 at a side apart from the female connector 3. The cover 10 receives electric wires joined with the female terminals for protecting the electric wires. The cover 10 is also provided with a limit projection 14 projecting therefrom for limiting a later-described operating plate 30 of the lever 4 by interfering with the lever 4 so as not to depart over a later-described first position from the female connector 3.

The inner housing 11 of the male connector 2 is provided at an outer wall thereof (top wall thereof in FIGS. 1, 2) with a lock arm 15. Thus, the lock arm 15 is arranged at the male connector 2.

The lock arm 15 includes an arm main body 16, an engaging projection 17, a pair of operating arms 18, an operating plate 19 and a pair of release projections 36. One end 16a of the arm main body 16 is continued to the outer wall of the inner housing 11, that is the male connector 2. The arm main body 16 extends linearly from the one end 16a toward the female connector 3. The other end 16b of the arm main body 16, close to the female connector 3, is a free end. The engaging projection 17 projects from the other end 16b of the arm main body 16 toward the inner housing 11.

A pair of operating arms 18 is formed respectively into a bar-shape. The pair of operating arms 18 is arranged in parallel with a space therebetween. The arm main body 16 is placed between the pair of operating arms 18. The operating arm 18 is continued to the other end 16b of the arm main body 16, and extends from the other end 16b of the arm main body 16 in a direction to be apart from the female connector 3.

The operating plate 19 connects both other ends of the operating arms 18 at the side apart from the female connector 3. The aforesaid operating plate 19 and the one end 16a of the arm main body 16 correspond to the other end of the lock arm 15 described in the claims of the present invention.

The pair of release projections 36 projects from the other end 16b of the arm main body 16 of the lock arm 15 toward the inner housing 11. The engaging projection 17 is arranged between the pair of release projections 36.

The aforesaid one end of the lock arm 15 having the arm main body 16 and the operating arm 18 is continued to the male connector 2, and the other end of the lock arm 15 is formed as a free end. When the connectors 2, 3 are fitted, after the engaging projection 17 of the lock arm 15 firstly abuts on a later-described lock projection 26, the arm main body 16 is elastically deformed so as to make the engaging projection 17 ride on the lock projection 26. Thereafter, the engaging projection 17 passes over the lock projection 26, and the arm main body 16 springs back to a neutral position not to be deformed elastically, and the engaging projection 17 is engaged with the lock projection 26. Thus, when the connectors 2, 3 are completely fitted together, the lock arm 15 is engaged with the lock projection 26. By engaging the lock arm 15 and the lock projection 26, the connectors 2, 3 are maintained in a complete fitting condition.

A pivot boss 20 (shown in FIG. 2) and a guide boss 21 (shown in FIG. 2) are provided projectingly from an inner surface of one outer wall of the outer cover 12, which is not overlapped with the lock arm 15. The pivot boss 20 is arranged in a central area of the one outer wall of the aforesaid outer cover 12. The guide boss 21 is located at a side apart more than the pivot boss 20 from the female connector 3 and close to the lock arm 15.

The female connector 3 includes a connector housing 22. The connector housing has a box-shape main body 23 and a tubular portion 24. The main body 23 is provided inside thereof with a terminal receiving section for mainly receiving a wire-connecting portion of a male terminal 25 (shown in FIG. 3). A lock projection 26 is provided on an outer wall of the main body 23. In other words, the female connector 3 is provided with the lock projection 26. The lock projection 26 is formed projectingly from the outer wall of the female connector 3.

The tubular portion 24 of the female connector 3 penetrates between the inner housing 11 and the outer cover 12 of the male connector 2, and the wire-connecting portion of the male terminal 25 penetrates into the terminal receiving section 13 of the inner housing 11 of the male connector 2, and the lock projection 26 is engaged to the engaging projection 17 of the lock arm 15. Thereby, the female connector 3 and the male connector 2 are fitted completely. The female connector 3 and the male connector 2 connect electrically the female terminal and the male terminal 25 so that the wires joined therewith are connected electrically. When the female connector 3 is fitted with the male connector 2, a part of the tubular portion 24 of the connector housing 22 penetrates between a later-described flat plate 29 of the lever 4 and the inner housing 11.

The female connector 3 is further provided with a fitting guide groove 27. The fitting guide groove 27 is formed by a pair of guides 28 arranged with a space to each other. The fitting guide groove 27 is the space between the pair of guides 28. The pair of guides 28 projects from the outer wall of the connector housing 22, that is the female connector 3. The fitting guide groove 27 extends linearly along a direction intersecting to a later-described access direction S from an edge, close to the male connector 2, of the tubular portion 24 of the female connector 3 toward an outside of the female connector 3. A width of the fitting guide groove 27 is wider than that of a later-described fitting guide projection 33 of the lever 4.

When the connectors 2, 3 are fitted together, the fitting guide projection 33 penetrates into the fitting guide groove 27. By rotating the lever 4 between a later-described first position and second position, the fitting guide projection 33 moves in the fitting guide groove 27. The fitting guide groove 27 in cooperation with the fitting guide projection 33 makes the connectors 2, 3 close to and apart from each other.

When the lever 4 is positioned at the second position, an inner wall 27a, at a side apart from the male connector 2, of the fitting guide groove 27 has a space between the fitting guide projection 33 and itself. When the interlocking release member 5 releases the engagement of the lock arm 15 and the lock projection 26 by rotating the lever 4, the fitting guide projection 33 abuts on the aforesaid inner wall 27a. When there is the space between the inner wall 27a of the fitting guide groove 27 and the fitting guide projection 33, even if the lever 4 is rotated, the connectors 2, 3 are nor moved to be close to and apart from each other.

Thus, the fitting guide groove 27 and the fitting guide projection 33 have the space A (shown in FIG. 16) therebetween. When the lever 4 is rotated from the second position toward the first position, there is the space between the fitting guide projection 33 and the inner wall 27a of the fitting guide groove 27 until the interlocking release member 5 releases the engagement of the lock arm 15 and the lock projection. Thereby, if the lever 4 is rotated, the connectors 2, 3 are stopped relatively to each other so that the connectors 2, 3 are maintained in a condition of complete fitting together. The space between the inner wall 27a of the fitting guide groove 27 and the fitting guide projection 33 corresponds to the fitting hold member described in claims of the present invention.

The lever 4 includes the flat plate 29 and the operating plate 30 standing from an outer edge of the flat plate 29 so as to be formed into an L-shape as a whole view when viewing from a side. The flat plate 29 is provided with a pivot oval hole 31 (shown in FIG. 2), a guide oval hole 32 (shown in FIG. 2) and the fitting guide projection 33 (shown in FIG. 4). The pivot oval hole 31 and the guide oval hole pass through the flat plate 29.

The pivot oval hole 31 is provided in a central area of the flat plate 29. The pivot boss 20 penetrates into the pivot oval hole 31. The pivot boss 20 penetrating into the pivot oval hole 31 can freely move in the pivot oval hole 31. The guide oval hole 32 is arranged closer to the operating plate 30 than the pivot oval hole 31. The guide boss 21 penetrates into the guide oval hole 32. The guide boss 21 penetrating into the guide oval hole 32 can freely move in the guide oval hole 32.

The pivot oval hole 31 and the guide oval hole 32 respectively extend in a circular-arc shape. A center of curvatures of the pivot oval hole 31 and the guide oval hole 32 is located at a position closer to the fitting guide projection 33 than the holes 31, 32 and more apart from the female connector than the fitting guide projection 33. The fitting guide projection 33 projects from the flat plate 29 toward the inner housing 11. The fitting guide projection 33 is located at a position more apart from the operating plate 30 than the pivot oval hole 31.

The pivot boss 20 penetrates into the pivot oval hole 31 and the guide boss 21 penetrates into the guide oval hole 32, thereby the flat plate 29 is located between the inner housing 11 and the aforesaid one outer wall of the outer cover 12. The pivot boss 20 moves in the pivot oval hole and the guide boss 21 moves in the guide oval hole 32. Thereby, the flat plate 29 is mounted on the connector housing 9, that is male connector 2, rotatably about one end thereof apart from the operating plate 30.

The flat plate 29 is located between the inner housing 11 and the outer cover 12, and rotates, thereby, the operating plate 30 is positioned at a position where the operating plate can be overlapped on the lock arm 15.

The aforesaid lever 4 is mounted on the male connector 2 so as to make the bosses 20, 21 penetrate into the oval holes 31, 32 and to have a gap against the inner housing 11. The lever 4 is supported rotatably about the one end thereof by the male connector 2. Furthermore, the fitting guide projection 33 provided at the lever 4 penetrates into the fitting guide groove 27 of the female connector 3. By rotating the lever 4 about the aforesaid one end, the fitting guide projection 33 slides (moves) in the fitting guide groove 27, thereby, the female connector 3 and male connector 2 are moved close to and apart from each other.

The lever 4 is mounted rotatably against the male connector 2 between the first position (shown in FIG. 2) where the lock arm 15 and the lock projection 26 can be separated completely, and the connectors 2, 3 are separated completely and the second position (shown in FIG. 14) where the lock arm 15 is engaged completely with the lock projection 26, and the connectors 2, 3 are fitted completely. At the second position, the lever 4 is received between the outer cover 12 and the inner housing 11 and the operating plate 30 overlaps over the lock arm 15. At the first position, the operating plate 30 of the lever 4 is exposed from a space between the outer cover 12 and the inner housing 11.

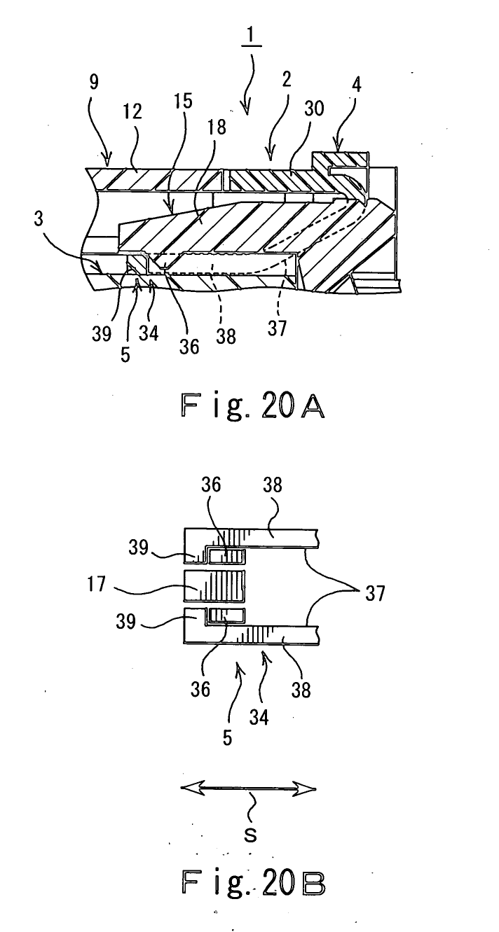

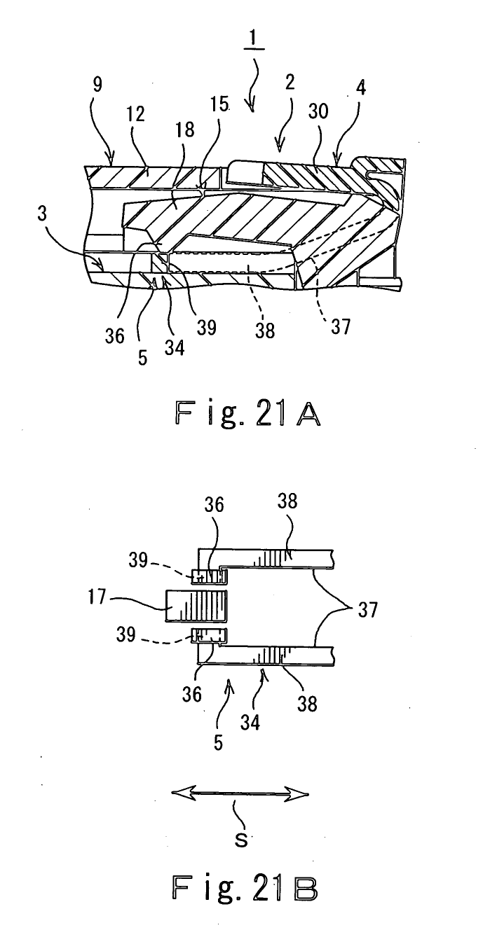

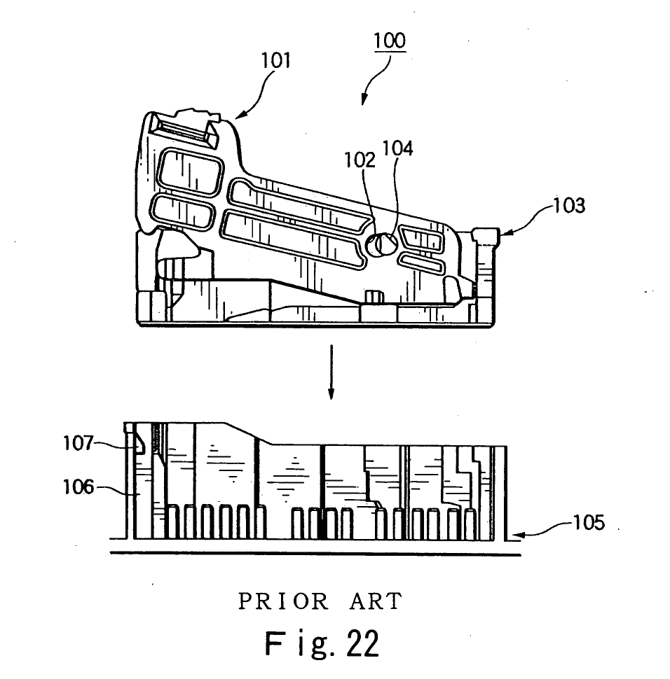

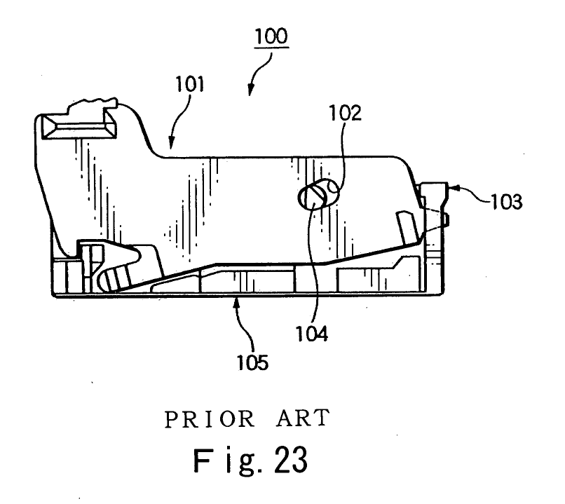

The interlocking release member 5 includes a first release member 34 (shown in FIG. 2) and a second release member 35 (shown in FIG. 15). The first release member 3 has a pair of release arms 37 as shown in FIGS. 20, 21.

The pair of release arms 37 is arranged with a distance to each other, and positions the arm body 16 of the lock arm 15 therebetween. The release arm has a bar-shape arm main body 38 extending from the operating plate 30 of the lever 4 toward the female connector 3, and an interference member 39 projecting from an end, close to the female connector 3, of the arm main body 38 in a direction that the pair of release arms 37 approaches to each other. Thus, the arm main body 16 is continued to the operating plate 30 of the lever 4 so that the release arm 37, that is the first release member 34, is arranged at the lever 4.

The interference member 39 is positioned between the arm main body 16 of the lock arm 15 and the inner housing 11. The interference member 39 is aligned together with the release projection 36 along the access direction S (shown with an arrow in FIG. 1) of the connectors 2, 3. The access direction S means a direction, in which connectors 2, 3 move relatively for making connectors 2, 3 close to and apart from each other for fitting and separating the connectors 2, 3.

When the lever 4 is positioned at the aforesaid second position, the interference member 39 is positioned closer to the female connector 3 than the release projection 36. When the lever 4 is positioned at the aforesaid first position, the interference member 39 is positioned apart from the female connector 3 than the release projection 36. During the lever 4 rotates between the first position and the second position, the interference member 39 abuts on the release projection 36 and deforms elastically the arm main body 16 of the lock arm 15 so as to make the engaging projection 17 apart from the lock projection 26 for riding the release projection 36 over the interference member 39. When the lever 4 starts to rotate from the second position toward the first position, the release projection 36 rides on the interference member 39.

According to the first release member 34 as structured above, when the lever 4 is positioned at the second position, in other words, the connectors 2, 3 are fitted together completely, and the lever 4 is rotated toward the first position, the interference member 39 penetrates between the release projection 36, that is the other end 16b of the lock arm 15 and the inner housing 11, that is male connector 2 so as to deform elastically the arm main body 16 of the lock arm 15 to release the engagement of the engaging projection 17 and the lock projection 26.

The second release member 35 has a pushing portion 40 projecting from the operating plate 30 of the lever 4 toward the male connector 2. A taper surface 41 is provided at a side, apart from the female connector 3, of the pushing portion 40. When the lever 4 is positioned at the second position, the taper surface 41 slants about the access direction S gradually toward outside of the male connector 2 in accordance with departing from the female connector 3.

When the lever 4 is positioned at the second position, the pushing portion 40 of the second release member 35 is located closer to the female connector 3 than the operating plate 19 of the lock arm 15. When the lever 4 is positioned at the first position, the pushing portion 40 of the second release member 35 is located more apart from the female connector 3 than the operating plate 19 of the lock arm 15. During the lever 4 rotates from the second position toward the first position, the pushing portion 40 abuts on the operating plate 19 of the lock arm 15 and pushes the one end of the lock arm 15 by the taper surface 41 toward the inner housing 11, that is the male connector 2.

The pushing portion 40 deforms the arm main body 16 of the lock arm 15 to make the engaging projection 17 apart from the lock projection 26. When the lever 4 starts to rotate from the second position toward the first position and the release projection 36 rides on the interference member 39 of the release arm 37, the pushing portion 40 pushes the operating plate 19 of the lock arm 15.

When the lever 4 rotates toward the first position from the second position in which the connectors 2, 3 are completely fitted, the pushing portion 40 pushes the operating plate, that is one end, of the lock arm 15 toward the inner housing, that is the male connector 2 to deform elastically the arm main body 16 of the lock arm 15 for releasing the engagement of the engaging projection 17 and the lock projection 26.

The guide groove 6 is formed to recess the operating plate 19 of the lock arm 15. In other words, the guide groove 6 is provided at the lock arm 15. The guide groove 6 extends linearly along the access direction S. The pushing portion 40 of the second release member 35 penetrates into the guide groove 6. When the lever 4 rotates, the pushing portion 40 penetrates into the guide groove 6 to guide the pushing portion 40 to move along the access direction S.

The pair of guide projections 7 is arranged with a space along a direction perpendicular to the access direction S. The pair of guide projections 7 is formed on an outer surface of the cover 10 of the male connector 2 projectingly from a position close to the lock arm 15. The pair of guide projections 7 is a wall extending linearly along the access direction S. When the lever 4 rotates, the pair of guide projections 7 passes the pushing portion 40 of the second release member 35 therebetween. When the lever 4 rotates, the pushing portion 40 penetrates between the pair of guide projections 7 so as to guide the pushing portion 40 of the second release member 35 to move along the access direction S.

The temporarily lock 8 includes a first temporarily lock 42 (shown in FIG. 2) and a second temporarily lock 43 (shown in FIG. 3). The first temporarily lock 42 is formed projectingly from the outer wall of the inner housing of the male connector 2 to be retractable from the outer wall. When the first temporarily lock 42 projects from the outer wall of the inner housing 11, the first temporarily lock 42 interferes with an outer edge of the lever 4 to hold the lever 4 at the first position.

When the connectors 2, 3 are fitted together, the first temporarily lock 42 is pushed to retract into an inside of the inner housing 11 by the tubular portion 24 of the female connector 3 so as not to interfere with the outer edge of the lever 4. Thereby, the first temporarily lock 42 releases a lock of the lever 4 in interlocking with making the connectors 2, 3 approach.

The second temporarily lock 43 has a vertical surface 44 provided at the pushing portion 40 and a vertical surface 45 provided at the operating plate 19 of the lock arm 15, as shown in FIG. 19. When the lever 4 is positioned at the second position, the vertical surfaces 44, 45 are formed in parallel to a direction perpendicular to the access direction S. The vertical surface 44 is provided at a position, close to the female connector 3, of the pushing portion 40. The vertical surface 45 is provided at a position, most apart from the female connector 3, of the operating plate 19. When the lever 4 is positioned at the first position, the second temporarily lock 43 hold the lever 4 on the male connector 2 by abutting the vertical surfaces 44, 45 to each other.

When the engaging projection 17 rides on the lock projection 26 for fitting the connectors together, the vertical surfaces 44, 45 depart from each other. The second engaging member 43 releases holding of the lever 4 with interlocking to approaching of the connectors 2, 3 to each other.

For fitting the male connector 2 and the female connector 3 of the set of connectors 1 to each other, by receiving the female terminals with electric wires in the connector housing 9, mounting the cover 10 and the lever 4 on the connector housing 9, the male connector 2 is assembled. By receiving the male terminals 25 with an electric wire in the connector housing 22, the female connector 3 is assembled.

Thereby, the lever 4 is held (positioned) at the first position as shown in FIGS. 1, 2 by the limit projection 14 and the temporarily lock 8. At that time, the pushing portion 40 is positioned between the pair of guide projections 7, and the vertical surfaces 44, 45 of the second temporarily lock 43 overlap on each other as shown in FIG. 19. The male connector 2 and the tubular portion 24 of the female connector 3 are opposed to each other as shown in FIGS. 1-4. Thereafter, the connectors 2, 3 are made close to each other, and the tubular portion 24 of the female connector 3 is inserted gradually into the outer cover 12 of the male connector 2 as shown in FIGS. 5, 6, and the inner housing 11 of the male connector 2 is inserted gradually into the tubular portion 24 of the female connector 3.

Thereby, the engaging projection 17 of the lock arm 15 rides on the lock projection 26, and the wire-connecting portion of the male terminal 25 penetrates gradually into the terminal receiving section 13 of the male connector 2 as shown in FIG. 7. The lock arm 15 is elastically deformed so as to make the other end 16b apart from the inner housing 11 as shown in FIGS. 7, 8. Furthermore, the fitting guide projection 33 penetrates into the fitting guide groove 27 as shown in FIG. 8.

When the inner housing 11 penetrates into the tubular portion 24 of the female connector 3, the lock of the lever 4 by the first temporarily lock 42 of the temporarily lock 8 is released. Furthermore, the operating plate 19 of the lock arm 15 approaches the inner housing 11, and the vertical surfaces 44, 45 are separated from each other. Thereby, the lock of the lever 4 by the second temporarily lock 43 of the temporarily lock 8 is released. Thus, the lever 4 is allowed to rotate toward the second position.

When the lever 4 rotates toward the second position, since the oval holes 31, 32 are formed into a circular arc shape, the fitting guide projection 33 moves toward a far side of the fitting guide groove 27 and apart from the female connector 3 in accordance with the rotation of the lever 4. Thereby, the fitting guide projection 33 moves slidingly in the fitting guide groove 27 and the connectors 2, 3 approaches to each in accordance with the rotation of the lever 4 from the first position toward the second position.

Thereafter, the pushing portion 40 penetrates from a space between the pair of guide projections 7 into the guide groove 6, as shown in FIGS. 9, 10. Thereby, the pushing portion 40 passes over the operating plate 19 of the lock arm 15 so as to be positioned closer to the female connector 3 than the operating plate 19, as shown in FIG. 11. Then, the release projection 36 rides on the interference member 39 as shown in FIG. 12.

Thereafter, the lever 4 further rotates toward the second position, so that the engaging projection 17 passes over the lock projection 26 so as to be positioned closer to the female connector 3 than the lock projection 26, as shown in FIG. 15. Then, the interference member 39 is positioned closer to the female connector 3 than the release projection 36, as shown in FIG. 16. Thereby, the lock arm 15 springs back to the neutral position without elastic deformation, and the engaging projection 17 is engaged with the lock projection 26. Then, the connectors 2, 3 are fitted completely, and the lever 4 is positioned at the second position as shown in FIGS. 13, 14. The lever 4 makes the fitting guide projection 33 placed in the fitting guide groove 27 and is maintained at the second position, so that the connectors 2, 3 are maintained in complete fitting condition. At this time, the fitting guide projection 33 has the space against the inner wall 27a of the fitting guide groove 27.

When the connectors 2, 3 are completely fitted, the pushing portion 40 provided at the operating plate 30 of the lever 4 is located closer to the female connector 3 than the operating plate 19 of the lock arum 15, as shown in FIG. 17. Furthermore, the engaging projection 17 is located closer to the female connector 3 than the lock projection 26, and the interference member 39 of the release arm 37 is located closer to the female connector 3 than the release projection 36 as shown in FIGS. 20A, 20B. The lock arm 15 is held in the neutral position without elastic deformation.

When the connectors 2, 3 fitted together are separated to each other, the lever 4 positioned at the second position is rotated toward the first position. The fitting guide projection 33 approaches the inner wall 27a of the fitting guide groove 27 in accordance with the rotation of the lever 4. Furthermore, the release projection 36 rides on the interference member 39 of the release arm 37, and the pushing portion 40 pushes the operating plate 19 toward the inner housing 11, as shown in FIGS. 21A, 21B.

Thereby, the lock arm 15 is elastically deformed so as to make the other end 16b apart from the inner housing 11, and the engagement of the engaging projection 17, that is the lock arm 15 and the lock projection 26 is released, as shown in FIG. 18. When the engagement of the engaging projection 17, that is the lock arm 15 and the lock projection 26 is released, the fitting guide projection 33 abuts on the inner wall 27a of the fitting guide groove 27. In accordance with the further rotation of the lever 4 toward the first position, the fitting guide projection 33 moves slidingly on the inner wall 27a, and the connectors 2, 3 are separated gradually. Thus, when the lever 4 is rotated from the second position toward the first position, the interlocking release member 5 releases the engagement of the lock arm 15 and the lock projection 26 in interlocking with the rotation of the lever 4 to release the fitting of the connectors 2, 3. During the first release member 34 and the second release member 35 of the interlocking release member 5 are releasing the engagement of the lock arm 15 and the lock projection 26, the connectors 2, 3 are not moved relatively to each other (stopped and not apart to each other owing to the space A between the fitting guide projection 33 and the inner wall 27a of the fitting guide groove 27).

According to the embodiment, the lever 4 maintaining fitting together of the male connector 2 and the female connector 3 is provided, and the lock arm 15 and the lock projection 26 to be engaged to each other for maintaining fitting of the male connector 2 and the female connector 3 are further provided. Without the lever 4, the fitting of the male connector 2 and the female connector 3 can be maintained.

Thereby, after fitting the connectors 2, 3 by the lever 4, the lever 4 can be removed. If the lever 4 is broken, the fitting of the connectors 2, 3 can be maintained. Therefore, the mechanical strength of the lever 4 can be reduced from that of the usual one by forming L-shape, so that the lever 4 can be miniaturized and the set of connectors 1 also can be miniaturized. In case, the set of connectors can be arranged so as to remove the lever 4. The space for arranging the set of connectors can be reduced, and the set of connectors can be arranged in a narrow space.

The interlocking release member 5 releases the engagement of the lock arm 15 and the lock projection 26 in interlocking with the rotation of the lever 4 for releasing the fitting of the connectors 2, 3. Thereby, the set of connectors 1 can be separated securely by rotating the lever 4. Thus, the connectors 2, 3 can be separated securely without damaging the lock arm 15 and the lock projection 26.

The release arm 37 of the first release member 34 of the interlocking release member 5 penetrates between the other end 16b of the lock arm 15 and the male connector 2, so that the engagement of the lock arm 15 and the lock projection 26 can be released securely.

The pushing portion 40 of the second release member 35 of the interlocking release member 5 pushes the operating plate 19 as the one end of the lock arm 15 toward the male connector 2, so that the engagement of the lock arm 15 and the lock projection 26 can be released securely.

The guide groove 6 for guiding the motion of the pushing portion 40 of the second release member 35 is provided at the operating plate 19 of the lock arm 15. Thereby, a direction of the rotation of the lever is guided by the pushing portion 40 of the second release member 35 and the guide groove 6. The pair of guide projections 7 locating the pushing portion 40 of the second release member 35 therebetween for guiding the motion of the pushing portion 40 of the second release member 35 is provided at the cover 10 of the male connector 2, on which the lever 4 is mounted. The direction of rotation of the lever 4 is guided by the pushing portion 40 of the second release member 35 and the pair of guide projections 7. Thereby, even if the mechanical strength of the lever 4 is reduced by miniaturizing the lever 4, the lever 4 will have no chances to be damaged. Therefore, the lever 4 can be more miniaturized.

Until the engagement of the lock arm 15 and the lock projection 26 is released, the space A makes the male connector 2 and the female connector 3 not move relatively (stop). Thereby, before the engagement of the lock arm 15 and lock projection 26 is released when the connectors 2, 3 are separated, the connectors 2, 3 are prevented from moving to separate from each other, so that the lock arm 15 and the lock projection 26 can be prevented from damage. Therefore, the connectors 2, 3 can be separated securely without damage of the lock arm 15 and the lock projection 26.

The space A is provided between the inner wall 27a of the fitting guide groove 27 and the fitting guide projection 33. Until the engagement of the lock arm 15 and the lock projection 26 is released, the male connector 2 and the male connector 3 do not move relatively securely. Thereby, the connectors 2, 3 can be separated securely from each other without the damage of the lock arm and the lock projection 26.

Since the set of connectors 1 has the temporarily lock 8, the lever 4 is prevented from rotating when the connectors 2, 3 are separated. Therefore, when the connectors 2, 3 are separated, it is prevented that the lever 4 is positioned at the second position to be positioned when the connectors 2, 3 are completely fitted.

In the aforesaid embodiment, the lever 4 is mounted on the male connector 2. According to the present invention, the lever 4 can be mounted on the female connector 3. In the embodiment, the lock arm 15 is provided at the male connector 2, on which the lever 4 is mounted, and the lock projection 26 is provided at the female connector 3, on which the lever 4 is not mounted. According to the present invention, the lock projection 26 can be provided at the male connector 2, on which the lever 4 is mounted, and the lock arm 15 can be provided at the female connector 3, on which the lever 4 is not mounted. In other words, according to the present invention, the lever 4 can be mounted on one of the connectors 2, 3, and (one of) the lock arm 15 (and the lock projection 26) can be provided at one of connectors 2, 3 and the other of the lock arm 15 (and the lock projection 26) can be provided at the other of connectors 2, 3.

In the above embodiment, the fitting guide projection 33 is provided at the lever 4 and the fitting guide groove 27 is provided at the female connector 3, which is the one of the connectors 2, 3, on which the lever 4 is not mounted. According to the present invention, the fitting projection 33 can be provided at one of connectors 2, 3, on which the lever 4 is not mounted, and the fitting guide groove 27 can be provided at the lever 4.

In the above embodiment, the interlocking release member 5 includes the both of the first release member 34 and the second release member 35. According the present invention, the interlocking release member 5 can include only the first release member 34 or only the second release member 35. In the other words, according to the present invention, the interlocking release member 5 can include at least one of the first release member 34 and the second release member 35. Therefore, according to the present invention, the release arm 37 of the first release member 34 can be eliminated.

In the above embodiment, the temporarily lock 8 includes the both of the first temporarily lock 42 and the second temporarily lock 43. According to the present invention, the temporarily lock 8 can includes only the first temporarily lock 42 or only the second temporarily lock 43. In the other words, according to the present invention, the temporarily lock 8 can include at least one of the first temporarily lock 42 and the second temporarily lock 43. According to the present invention, the above guide groove 6 can be eliminated.

While the described embodiment represents the preferred form of the present invention, it is to be understood that the present invention is not limited thereto. Therefore, various change and modifications can be made with the scope of the present invention.

What is claimed is:

1. A set of connectors, comprising:
a first connector having a lock arm;
a second connector having a lock projection to be engaged with said lock arm, and fitting with said first connector by engaging the lock projection and the lock arm;
a lever provided rotatably on any one of the first connector and the second connector so as to rotate for moving the first connector and the second connector to be close to each other and be apart from each other;
interlocking release member releasing engagement of the lock arm and the lock projection by interlocking with a rotation of the lever for separating the first connector and the second connector, which are fitted together, from each other; and
a fitting hold member holding to fit the first connector and the second connector together until the engagement of the lock arm and the lock projection is released even if the lever rotates.

2. The set of connectors according to claim 1, wherein one end of the lock arm is continued to the first connector and the other end of the lock arm is formed into a free end to be engaged with the lock projection of the second connector, wherein the interlocking release member includes a first release member provided at the lever for deforming elastically the lock arm so as to release the engagement of the lock arm and the lock projection by penetrating between the first connector and the other end of the lock arm when the lever is rotated in a condition that the first connector and the second connector are fitted together.

3. The set of connectors according to claim 1, wherein one end of the lock arm is continued to the first connector and the other end of the lock arm is formed into a free end to be engaged with the lock projection of the second connector, wherein the interlocking release member includes a second release member provided at the lever for deforming elastically the lock arm so as to release the engagement of the lock arm and the lock projection by pushing the one end of the lock arm toward the first connector when the lever is rotated in a condition that the first connector and the second connector are fitted together.

4. The set of connectors according to claim 3, wherein the second release member includes a pushing portion projecting from the lever toward the lock arm, and a guide groove provided at the lock arm and extending in a direction of moving the first connector and the second connector to be close to and apart from each other for guiding motion of said pushing portion to penetrate into the guide groove when the lever is rotated.

5. The set of connectors according to claim 3, wherein any one of the first connector and the second connector, on which the lever is provided, is provided with a pair of guide projections extending in the direction of moving the first connector and the second connector to be close to and apart from each other for guiding motion of said pushing portion to penetrate between the pair of guide projections when the lever is rotated.

6. The set of connectors according to claim 1, wherein a fitting guide projection is provided on any one of the other of the first connector and the second connector and the lever, and said fitting guide projection projects toward the other of the other of the first connector and the second connector and the lever, and a fitting guide groove, into which the fitting projection penetrates, is provided the other of the other of the first connector and the second connector and the lever, and the first connector and the second connector are moved to be close to and apart from each other by moving the fitting guide projection in the fitting guide groove when the lever is rotated,
wherein the fitting hold member is formed with a space arranged between the fitting guide projection and the fitting guide groove so as to remain said space between the fitting guide projection and the fitting guide groove until the interlocking release member releases the engagement of the lock arm and the lock projection.

7. The set of connectors according to claim 1, wherein a temporarily lock is provided for locking the lever when the first connector and the second connector are separated, and releasing a locking of the temporarily lock interlockingly with approaching of the first and second connectors to each other when the first and second connectors are fitted.

8. The set of connectors according to claim 2, wherein one end of the lock arm is continued to the first connector and the other end of the lock arm is formed into a free end to be engaged with the lock projection of the second connector, wherein the interlocking release member includes a second release member provided at the lever for deforming elastically the lock arm so as to release the engagement of the lock arm and the lock projection by pushing the one end of the lock arm toward the first connector when the lever is rotated in a condition that the first connector and the second connector are fitted together.

9. The set of connectors according to claim 8, wherein the second release member includes a pushing portion projecting from the lever toward the lock arm, and a guide groove provided at the lock arm and extending in a direction of moving the first connector and the second connector to be close to and apart from each other for guiding motion of said pushing portion to penetrate into the guide groove when the lever is rotated.

10. The set of connectors according to claim 4, wherein any one of the first connector and the second connector, on which the lever is provided, is provided with a pair of guide projections extending in the direction of moving the first connector and the second connector to be close to and apart from each other for guiding motion of said pushing portion to penetrate between the pair of guide projections when the lever is rotated.

11. The set of connectors according to claim 2, wherein a fitting guide projection is provided on any one of the other of the first connector and the second connector and the lever, and said fitting guide projection projects toward the other of the other of the first connector and the second connector and the lever, and a fitting guide groove, into which the fitting projection penetrates, is provided the other of the other of the first connector and the second connector and the lever, and the first connector and the second connector are moved to be close to and apart from each other by moving the fitting guide projection in the fitting guide groove when the lever is rotated,
wherein the fitting hold member is formed with a space arranged between the fitting guide projection and the fitting guide groove so as to remain said space between the fitting guide projection and the fitting guide groove until the interlocking release member releases the engagement of the lock arm and the lock projection.

12. The set of connectors according to claim 3, wherein a fitting guide projection is provided on any one of the other of the first connector and the second connector and the lever, and said fitting guide projection projects toward the other of the other of the first connector and the second connector and the lever, and a fitting guide groove, into which the fitting projection penetrates, is provided the other of the other of the first connector and the second connector and the lever, and the first connector and the second connector are moved to be close to and apart from each other by moving the fitting guide projection in the fitting guide groove when the lever is rotated,
wherein the fitting hold member is formed with a space arranged between the fitting guide projection and the fitting guide groove so as to remain said space between the fitting guide projection and the fitting guide groove until the interlocking release member releases the engagement of the lock arm and the lock projection.

13. The set of connectors according to claim 4, wherein a fitting guide projection is provided on any one of the other of the first connector and the second connector and the lever, and said fitting guide projection projects toward the other of the other of the first connector and the second connector and the lever, and a fitting guide groove, into which the fitting projection penetrates, is provided the other of the other of the first connector and the second connector and the lever, and the first connector and the second connector are moved to be close to and apart from each other by moving the fitting guide projection in the fitting guide groove when the lever is rotated,
wherein the fitting hold member is formed with a space arranged between the fitting guide projection and the fitting guide groove so as to remain said space between the fitting guide projection and the fitting guide groove until the interlocking release member releases the engagement of the lock arm and the lock projection.

14. The set of connectors according to claim 5, wherein a fitting guide projection is provided on any one of the other of the first connector and the second connector and the lever, and said fitting guide projection projects toward the other of the other of the first connector and the second connector and the lever, and a fitting guide groove, into which the fitting projection penetrates, is provided the other of the other of the first connector and the second connector and the lever, and the first connector and the second connector are moved to be close to and apart from each other by moving the fitting guide projection in the fitting guide groove when the lever is rotated,
wherein the fitting hold member is formed with a space arranged between the fitting guide projection and the fitting guide groove so as to remain said space between the fitting guide projection and the fitting guide groove until the interlocking release member releases the engagement of the lock arm and the lock projection.

15. The set of connectors according claim 2, wherein a temporarily lock is provided for locking the lever when the first connector and the second connector are separated, and releasing a locking of the temporarily lock interlockingly with approaching of the first and second connectors to each other when the first and second connectors are fitted.

16. The set of connectors according to claim 3, wherein a temporarily lock is provided for locking the lever when the first connector and the second connector are separated, and releasing a locking of the temporarily lock interlockingly with approaching of the first and second connectors to each other when the first and second connectors are fitted.
